(19) United States
(12) Patent Application Publication
(10) Pub. No.: US 2004/0237380 A1
(43) Pub. Date: Dec. 2, 2004

(54) Apparatus and methods for detecting and monitoring termite activity

(76) Inventor: Bradley Carpenter, Narangba (AU)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/488,293

(22) PCT Filed: Sep. 3, 2002
(86) PCT No.: PCT/AU02/01201

(30) Foreign Application Priority Data
Sep. 3, 2001 (AU) PR 7443

(51) Int. Cl. A01M 1/20

(52) U.S. Cl. 43/132.1

(57) ABSTRACT

A termite detection and monitoring apparatus including a container (50) configured to hold a quantity of termite attractive food, the container (50) having at least one access opening (58) to enable termite access to the food; a termite interceptor (10) adapted to direct termites into the container (50), one end of the enterceptor (10) communicating with an access opening (58) of the container (50) and the other end of the interceptor (10) extending in a direction away from the container (50), and a termite activity indicator (60) associated with the container (50) adapted to indicate a predetermined level of termite activity in the container (50).

### FIELD OF THE INVENTION

This invention is generally related to apparatus and methods for detecting and monitoring termite activity and for illustrative purposes reference will be made to such application. However, it is to be understood that this invention may be adapted to other colony or infestation insects such as fire ants, black ants, cockroaches or the like based on their natural instincts of colonisation.

### BACKGROUND OF THE INVENTION

Termites, often called white ants, cause hundreds of millions of dollars in damage to buildings in Australia alone, let alone with considering the damage cause throughout the world each year. There are a large number of different species of termite in Australia, but only about six subterranean species are serious pests with one of those, “coptotermes ancinaciformis” being responsible for more economic loss than all the other Australian species combined.

Termites are social insects living together in complex societies where thousands to millions of individuals act together as one entity. The termite society is typically made up of a single queen, who may live up to 50 years, and a shorter lived and replaceable king, soldiers, workers and alates. The workers live for several years and are sterile, blind and work non-stop 24 hour a day. The subterranean species builds galleries or tubes underground and usually travel in the uppermost 40 mm of soil where tunnelling is easier and where food sources are more plentiful. This is because they cannot tolerate light.

The primary function of the worker is to gather cellulose, which is found in timber, cardboard and paper products. Accordingly, it is the worker that causes the structural damage to buildings whilst looking for a suitable food source to support the termite nest. When a worker locates a food source, they emit pheromones that are detected and enhanced by other workers, thereby attracting large numbers to the located food source. The workers then digest and transport cellulose back to the nest that may be more than 100 metres away from the food source.

There is known a number of different methods in the art that are currently employed to attempt to control termite infestation. A primary method of preventing termite infestation for many years has been to apply a chemical treatment of the soil under and around buildings to attempt to create a chemical barrier. However, some of the chemicals used in the past have been highly toxic, for example, organochlorins, which are now believed to be carcinogenic and use of which has been banned in Australia since 1995. Other less toxic chemicals, particularly, organophosphates such as those sold under the trade marks “Dursban” (chlorpyrifos) and “Biflex” (synthetic pyrethroid) are now widely used. Although these poisons have a shorter active life than the organochlorins and residual problems are significantly lessened they are still dangerous and environmentally unfriendly. Further, in order to maintain a suitable barrier to termite infestation, re-treatments need to be done every one to three years, depending on soil type, building type, climate, location and other factors. In many cases, the chemical barrier is leached from the soil around buildings by heavy rain with the result that the chemical barrier is interrupted or destroyed altogether thereby leaving the building open to attack by termites.

Various mechanical barriers are also available. One well known mechanical barrier which has been used in Australia for many years is an “Antcap”. Antcaps are typically constructed of galvanised steel and are placed on top of the underfloor piers and stumps of buildings to form a barrier to paths which termites might take from the ground into the building such as through the stumps. Another mechanical barrier sold under the trade mark “Termi-mesh” is a stainless steel gauze type fabric which is installed beneath concrete slabs and foundations, within wall cavities, between courses of bricks or immediately on top of the damp course layer. Another mechanical barrier sold under the trade mark “Granitgard” provides a layer of crushed rock of uniform particle size and is installed in similar positions to Termi-mesh.

All of these methods described may provide barriers to termites, but in practice do not significantly contribute to the detection and monitoring of termites around buildings and once these so-called barriers are breached the termites can rapidly infest and destroy the building. The breaches may be made by human error or by the fact that termites have been known to chew through brick, mortar, concrete, plastics, rubber and even some metals in a relentless search for a food source. Though the workers are blind, they constantly are constantly foraging. As such, if there is a minor breach in a mechanical barrier it is likely that a termite with find this breach.

Other methods of controlling termite infestation rely on baiting the termite with “bait stations” that are hopeful to entice the termites to the bait station in lieu of a building and if enticed the termites are hopefully then eradicated before they can locate the building. Known bait stations in the art generally require the installation of numerous small “station” containers in selected locations around a building with food suitable for termites in the containers. The bait stations are manually checked on a regular basis and when termite-activity is noticed, the food is replaced by new food laced with a toxicant which is then taken to the nest by the worker termites, where it affects the entire colony, through them ingesting the secretions of others, grooming, and eating the dead and dying termites. Such type of toxicant will be referred to hereinafter as a “carrier poison”.

There are a number of bait stations well known in the art that comprises an outer housing that is implanted into the ground with an inner housing that contains a food source for termites. These bait stations require continuous manual inspection and if termites are detected then the food source is removed and the bait saturated with a termite toxin is then substituted into the inner housing. However, 1f any light and/or air comes into contact with any infecting termites they will be disturbed returning to their nest and may not travel back to the bait station for many months. In this regard, if the inner housing is disturbed in order to view the activity of the termites or 1f food source contained in the housing is replaced with an active bait, it is likely that the infesting termites will be scared away prior ingesting any termite toxin. The termites may not return for many months defeating the purpose of the initial detection and later control aspects of bait station.

Another method of controlling termites relies on worker termites transporting a carrier poison to the nest and involves dusting a number of worker termites with a poison, particularly arsenic trioxide, which they then carry to the nest when they return with food and the same process results in the death of the colony. Various methods of dusting termites are used, for example, dusting existing termite galleries and relying on the termites to pick up sufficient dust as they move through the galleries. The problem with this method is that it requires the ability to accumulate the capture of a sufficient amount of termites to allow efficient dusting that will eventually destroy the queen and the nest.

The various methods of the prior art provide many disadvantages. We have found various desirable methods and apparatus for detecting and monitoring termite activity that may not unnecessarily disturb the termite activity until sufficient numbers of termites have accumulated to enable a more effective application of termite toxicant or carrier poison to captured termites that will hopefully provide the most effective means of destroy a termite nest.

### SUMMARY OF THE INVENTION

This invention resides in one aspect resides in termite detection and monitoring apparatus including:

a container configured to hold a quantity of termite attractive food, the container having at least one access opening to enable termite access to the food;

a termite interceptor adapted to direct termites into the container, one end of the interceptor communicating with an access opening of the container and the other end of the interceptor extending in a direction away from the container, and

a termite activity indicator associated with the container adapted to indicate a predetermined level of termite activity in the container.

The container may include one or more walls defining a chamber having a food input opening and a removable closure adapted to close the opening. The chamber is adapted to contain the food attractive to termites. Preferably, there is a plurality of access openings. The chamber may be partitioned into two or more sectioned levels.

In preferred embodiments, the interceptor includes a food source located within a gallery in order to entice termites into the container via communication with an access opening. The interceptor may communicate with at least one access opening of the container by any suitable means. Suitably, the interceptor is arranged so that the galleries extend into or communicate with the termite collection containers to allow termite access into the container. Accordingly, the termites travelling in the galleries can enter a termite collection container to obtain food which is placed therein. Suitably, the interceptors are positioned so that a termite is more likely to strike the interceptor than a building or other commercial structure.

Suitably the termite interceptor may be installed at least part way around a building so that the likelihood that termite infestation is more likely to occur in the interceptor or collection container than the building. The interceptor may be considered an invention in its own right and is defined in more detail below.

The termite activity indicator may include any device that emits any suitable signal upon infestation of the container so that a suitable monitoring and/or control procedure may be put into action. The emitted signal may include a visual, electrical, infrared, radio, wireless satellite, GPS or any other telemetric signal that can be suitably registered for action.

There are various number of other indicators that may be used to continually monitor the activity of termite infestation of the container once initial termite activity has been registered. These indicators may include viewers that allow optical viewing of the contents of the container with our disturbing any infesting termites or may include an tube extending therethough the depth of the container, the tuber containing a termite food source such that upon extraction of the tube from the container a viewer can visually inspect the extent of termite activity in the container.

Once a sufficient amount of termites has been detected in the container, the pests may be controlled as a result of ingesting or otherwise contacting a toxicant. The subject invention has been discovered to be highly effective in controlling even extremely large termite colonies. Advantageously, the control method utilizes very small amounts of toxicant, and this toxicant is applied in a strictly defined and controlled manner to minimize exposure of the environment to toxicants. The use of toxicant is confined in terms of the very limited quantity and coverage of the toxicant, and in terms of the period during which the toxicant is used. Once control is attained, the monitoring step can continue.

Suitably, the termites that aggregate and are detected in the container may be removed, dusted and then returned to the site of activity. A preferred method which for controlling the termites once sufficient activity is detected in the container relies on worker termites transporting a carrier poison to the nest via dusting of a sufficient number of worker termites with a poison, particularly arsenic trioxide, which they then carry to the nest when they return with food and the same process results in the death of the colony. Whichever strategy is employed, success suitably depends on the aggregated termites taking a slow-acting toxin back to the nest which eventually kills or suppresses the colony.

Triflumuron may also be a suitably dust applicant depending on the registration requirements of a relevant country. Various biological control may also be employed to control the termite infestation.

Thought the preferred termite toxicant is arsenic trioxide, a number of chitin-synthesis inhibitors have developed. For example, hexaflumuron and triflumuron and metabolic inhibitors such as hydramethylnon and sulfluramid have been found to have delayed activity against some termites. As a bait toxicant, they can be used to manage foraging populations of subterranean termite colonies, thereby reducing damage potential.

Thought the preferred embodiment of this invention resides in at least partially installing the above described apparatus in the ground, the invention could just as easily be installed within a building. For example, the container and the termite activity indicator could be installed within a wall cavity and the interceptor could extend further into the wall cavity and behind skirting boards. It is to be understood that a person skilled in the art would be to camouflage termite detection and monitoring apparatus of the invention within the structure of a building using the skills they have already acquired without undue research and/or experimentation.

In a further aspect, the invention may reside a method of detecting and/or monitoring termite infestation of a building including:

providing a termite interceptor as previously described within the vicinity of a building to be protected;

providing a termite collection container and providing communication between the termite interceptor and the container to termite access openings to enable of travel termites from the interceptor into collection container, and providing a termite activity indicator associated with the container to detect a predetermined level of termite activity in the container,

wherein upon detection a predetermined level of termite activity within the contain treatment steps are undertaken to treat the termites collected in the collection container with a carrier poison.

In a still further aspect, this inventions resides in a termite interceptor adapted to be installed in the ground, the interceptor having one or more walls defining an elongate gallery extending over substantially the full length of the interceptor and being adapted to contain therein a quantity of food attractive to termites, a plurality of termite access openings in at least one of said one or more walls adapted to provide access for termites to said gallery from the adjacent ground, and a food input opening in one of said one or more walls adapted to allow placement of food for termites in said gallery.

The gallery may have a food input opening or openings along substantially its full length adapted to receive therethrough the food attractive to termites. Suitably, the food input opening or openings are adapted to close by a removable closure or closures. The termite attractive food may be a piece of timber that is adapted to be arranged in the gallery to engage at least one wall containing the termite access opening.

In further aspect the invention resides in a termite collection container including:

one or more walls defining a chamber having a food input opening, said chamber being adapted to contain food attractive to termites and a removable closure adapted to close said food input opening;

a termite access opening in at least one of said one or more walls to provide access for termites to said chamber;

a termite activity indicator operatively connected to said chamber and adapted to indicate a predetermined level of termite activity in said chamber, and actuating means for actuating said termite activity indicator.

In a preferred form said actuation means includes a food article which is particularly attractive to termites which when eaten by termites in the chamber allows the termite activity indicator to move from a non-activity indicating position to an activity indicating position. Suitably movement to a termite activity indicating position may enable the emission of a visual, electrical, infrared, radio, wireless satellite, GPS or any other telemetric signal to enable a householder, a professional or other monitoring station to register the termite activity to enable action to control and/or exterminate the termite activity.

### DETAILED DESCRIPTION OF THE INVENTION

In order that this invention may be more readily understood and put into practical effect, reference will now be made to the accompanying drawings which illustrate preferred embodiments of the invention wherein:

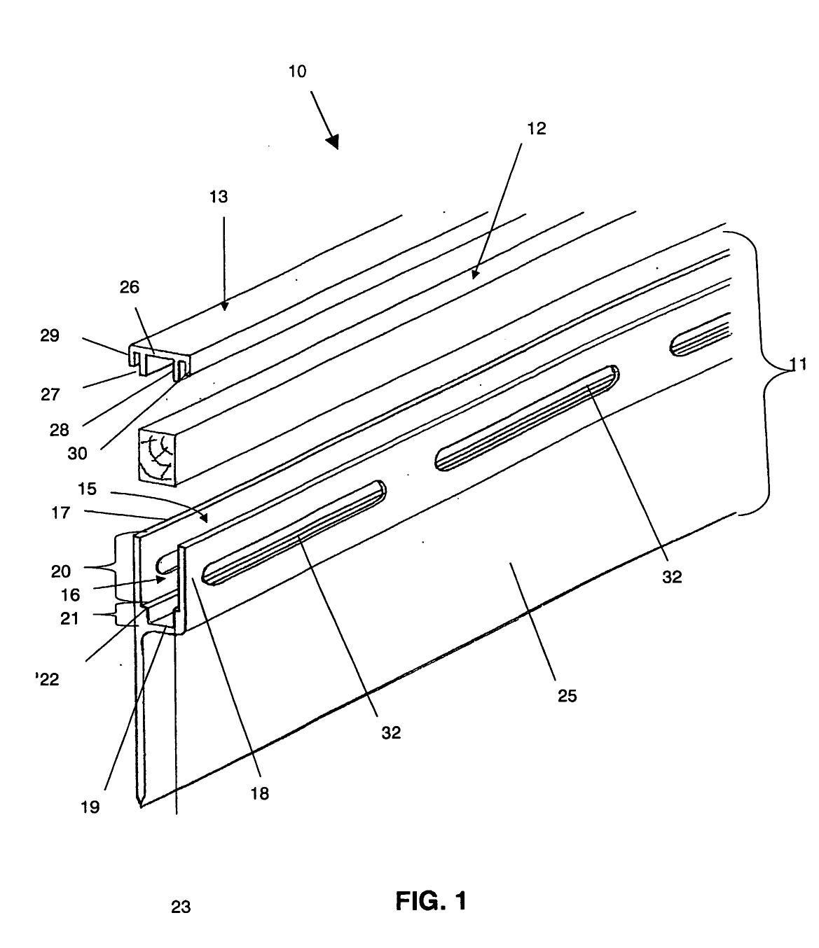

FIG. 1 is a pictorial representation of a termite interceptor according to the invention, the three main components in line for assembly;

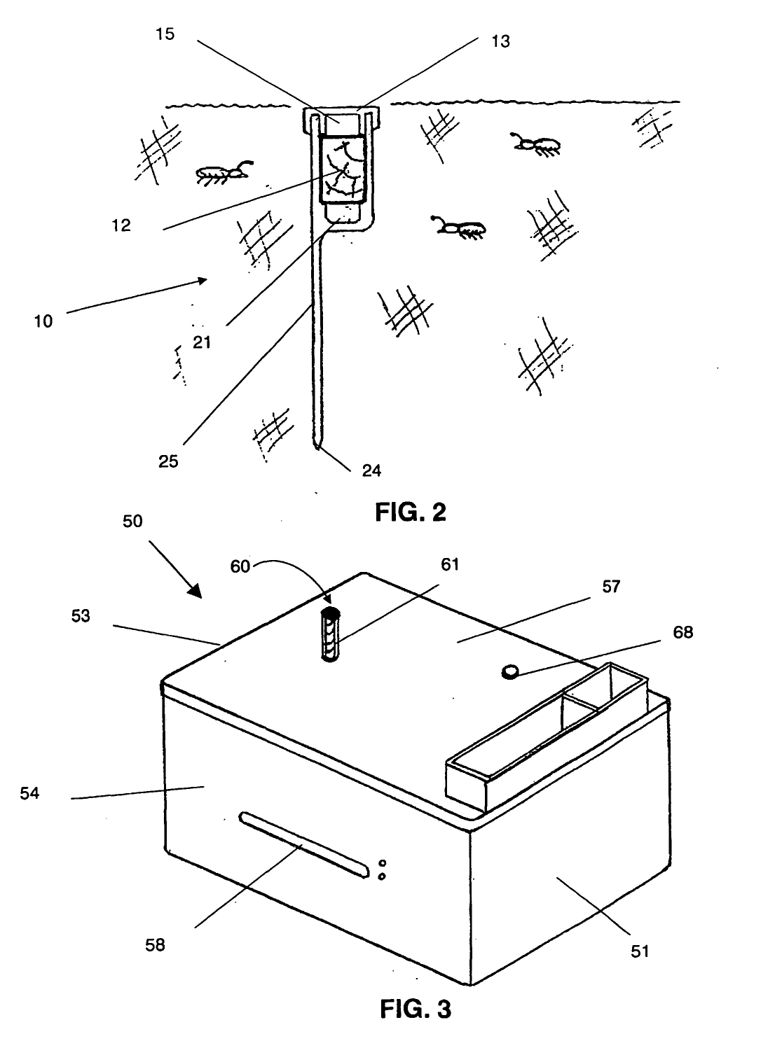

FIG. 2 is a sectional end elevation of the termite barrier of FIG. 1 installed in the ground and ready for use;

FIG. 3 is a pictorial representation of a termite collection container according to the invention;

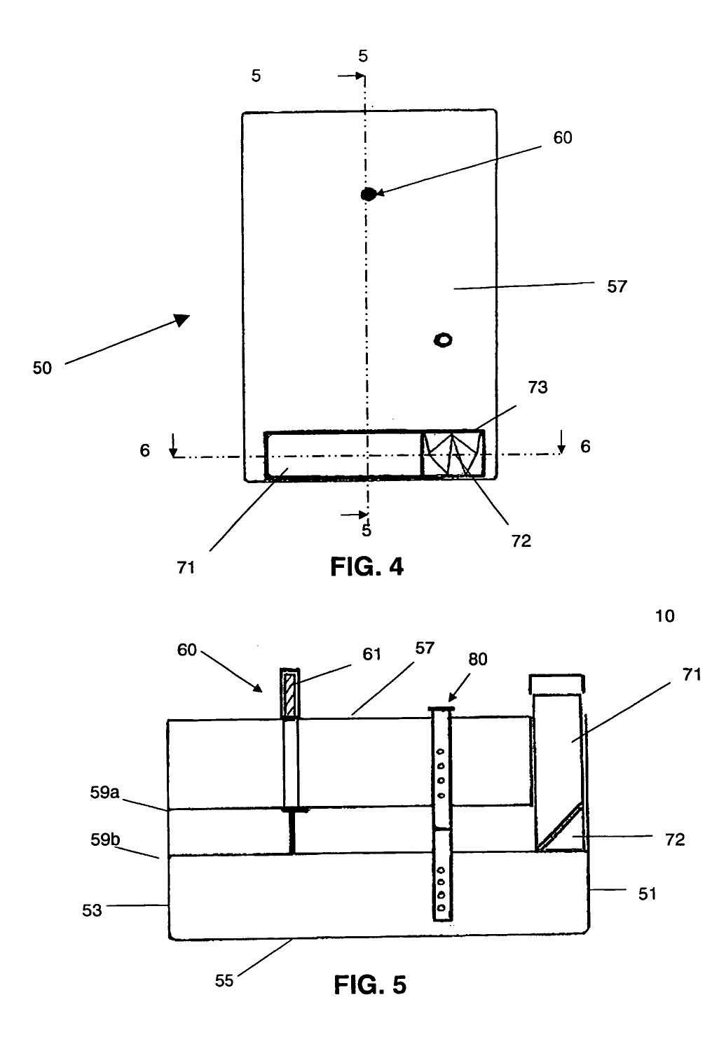

FIG. 4 is a plan view of the termite collection container of FIG. 3;

FIG. 5 is a sectional elevation of the termite collection container of FIG. 3 along line 5-5;

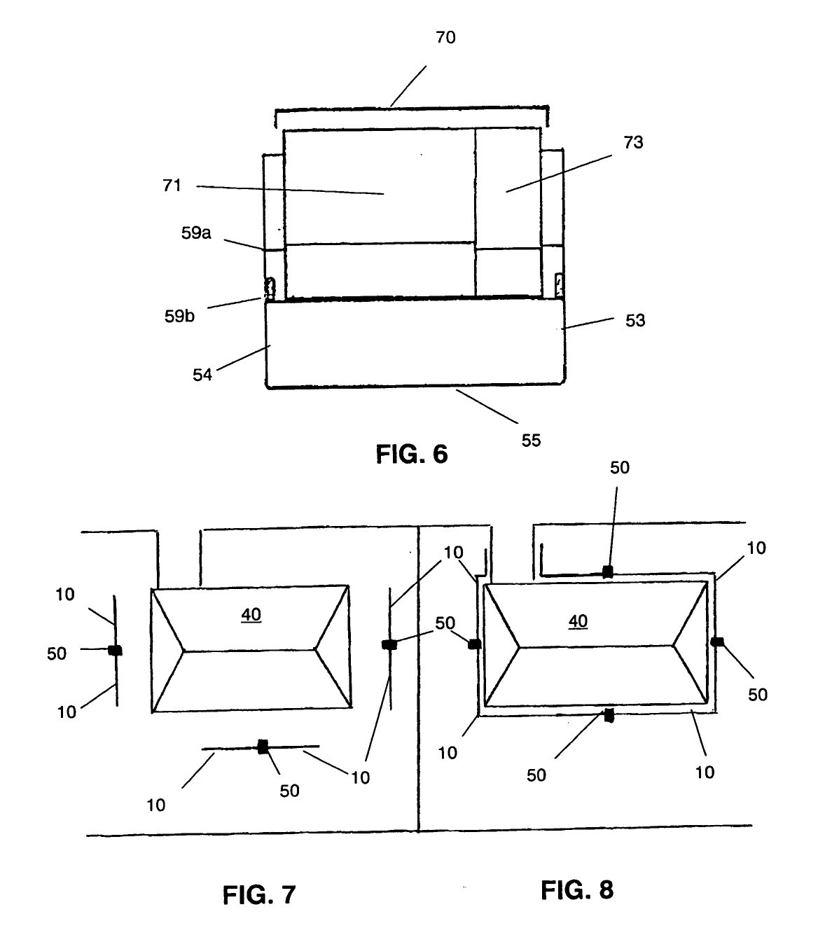

FIG. 6 is a sectional end elevation of the termite collection container of FIG. 4 along line 6-6;

FIG. 7 is a diagrammatic plan view of a termite barrier installed around a house yard according to the invention;

FIG. 8 is a diagrammatic plan view of a termite barrier installed adjacent the perimeter of a house according to the invention;

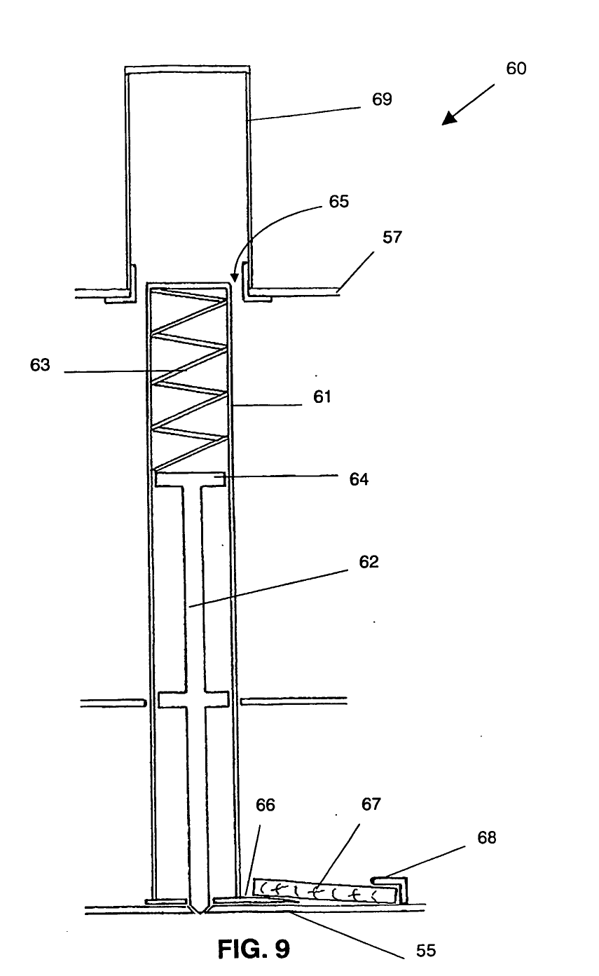

FIG. 9 is a sectional elevation of the activity indicator component of the termite collection chamber of FIG. 3 in the retracted position;

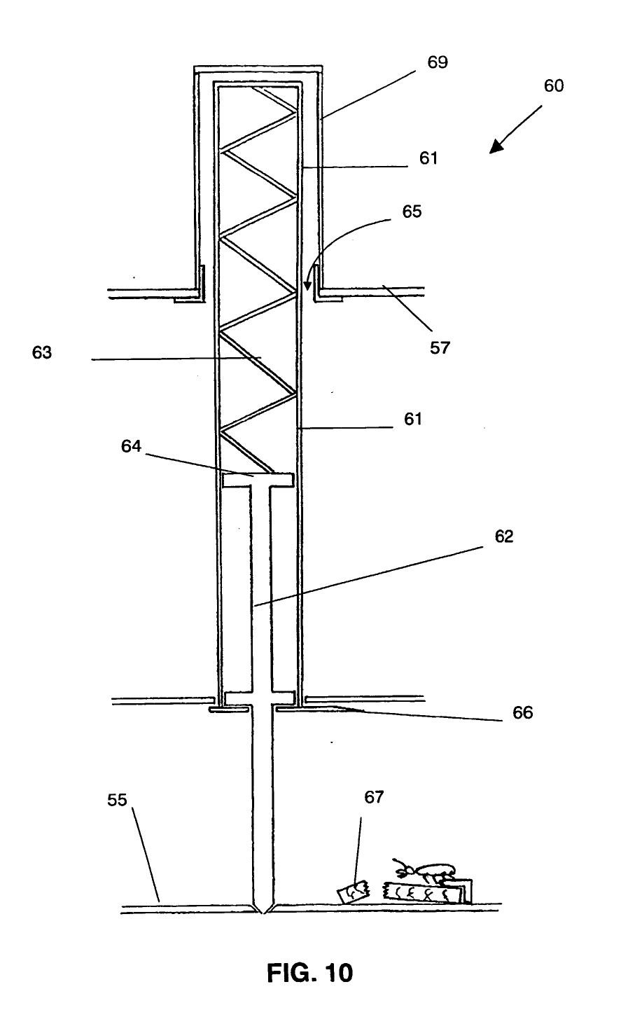

FIG. 10 is a sectional elevation of the activity indicator of the termite collection chamber of FIG. 3 in the extended position,

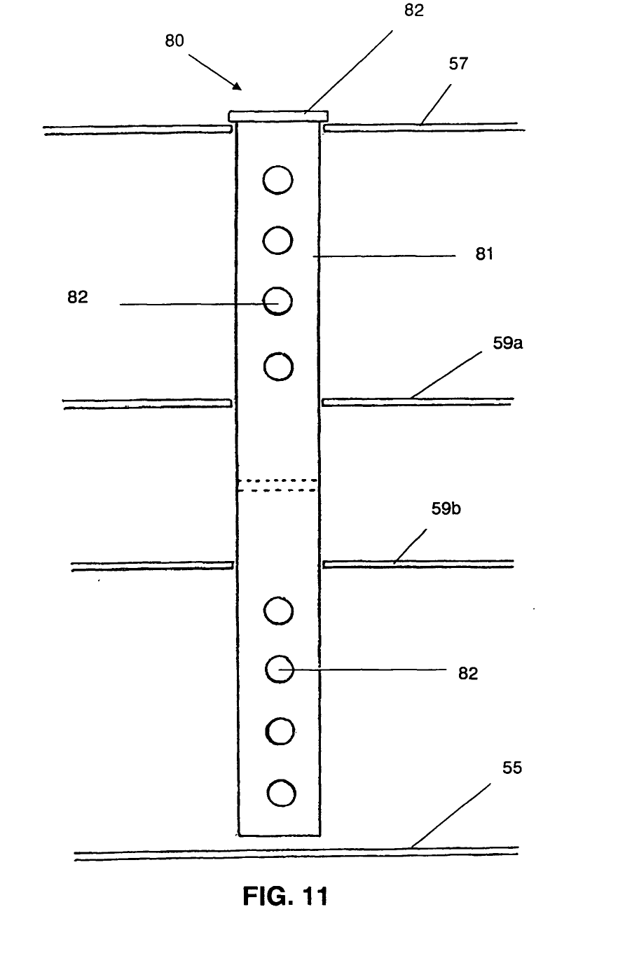

FIG. 11 is a sectional elevation of a secondary activity indicator component of the termite collection chamber of FIG. 3;

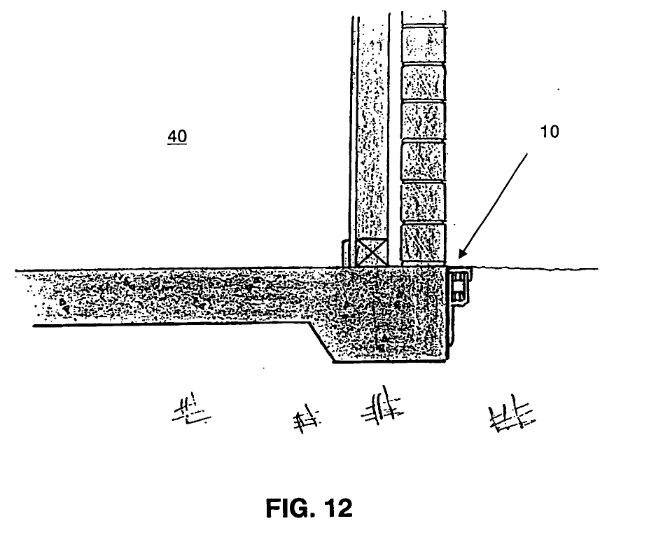

FIG. 12 is a sectional end elevation of part of a slab-on ground house showing a termite barrier installed according to the present invention;

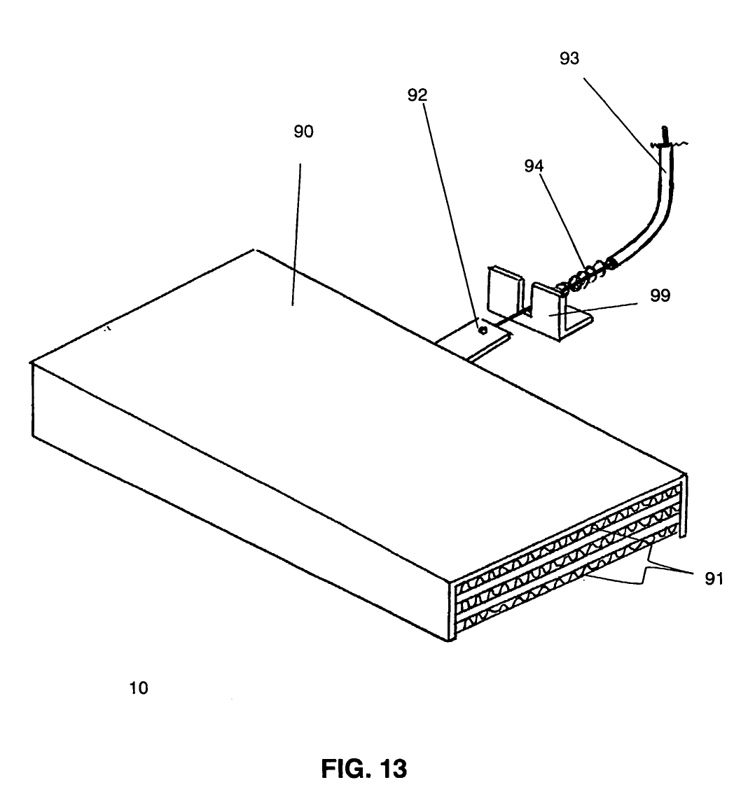

FIG. 13 is a perspective view of an alternate embodiment of an activity indicator assembly;

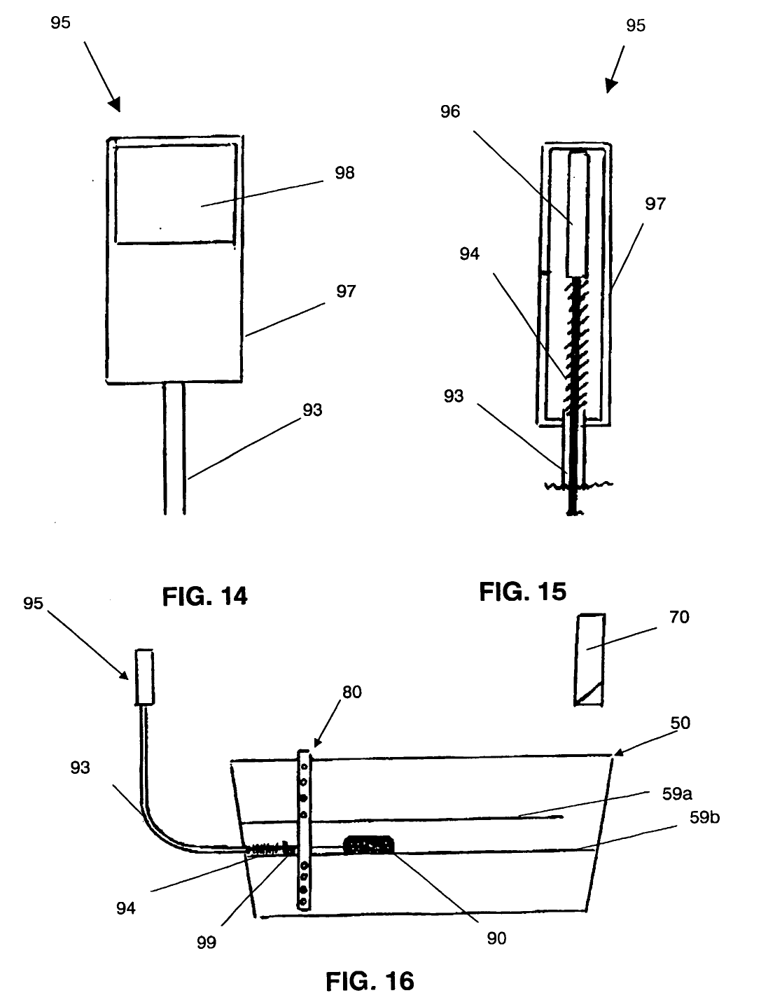

FIG. 14 is front view of the indicator of the activity indicator assembly shown in FIG. 13;

FIG. 15 is a side section view of the indicator shown in FIG. 14 in an extended position;

FIG. 16 is a sectional view of the termite collection container containing the alternative embodiment of the activity indicator assembly shown in FIGS. 13 to 15, and

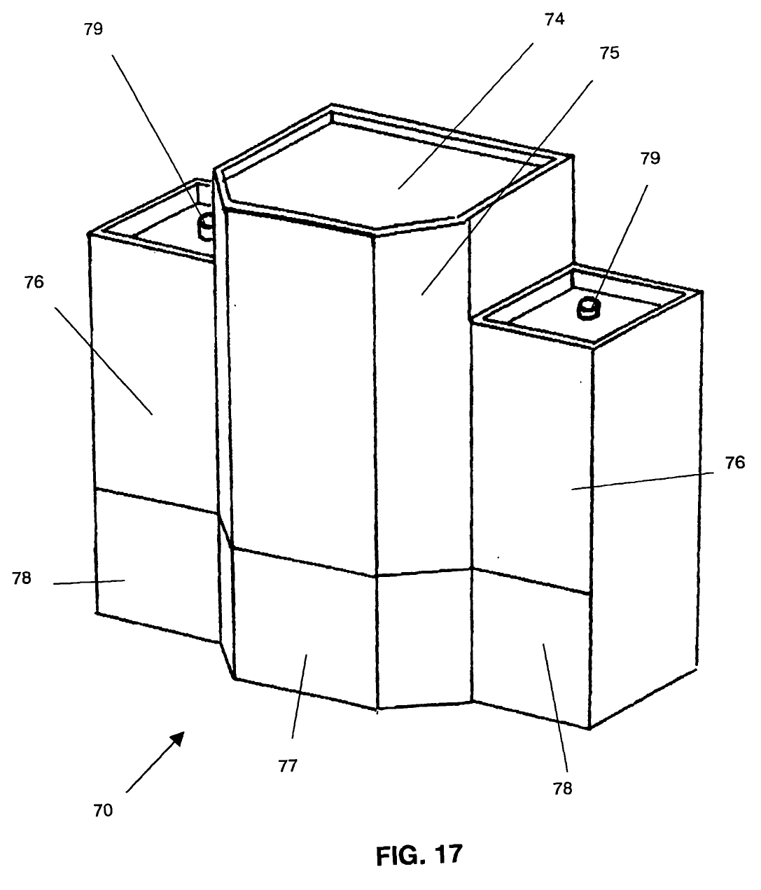

FIG. 17 is a pictorial representation of one embodiment of an optical viewer.

### EXAMPLE 1

The termite interceptor 10 used in the termite detection and monitoring apparatus and methods of the described invention is illustrated in FIG. 1. The interceptor has three main components, an elongated base component 11 constructed of a plastics material, an elongated softwood timber insert 12, and an elongated closure 13 also constructed of a plastics material.

A substantially U-shaped gallery 16 defined by a rear wall portion 17, a front wall portion 18 spaced from the rear wall portion 17 and a base wall portion 19 extending between the rear wall portion 17 and the front wall portion 18 and integral therewith, while the upper free edges of the front and rear wall portions 17 and 18 define an elongate opening 15 extending over the full length of the base component 11. The gallery 16 has a wide rectangular upper portion 20 adapted to hold the timber insert 12 therein and a narrower lower portion 21 which forms a passage along the length of the gallery 16 beneath the timber insert 12, the lower portion 21 being distinguished from the upper portion 20 by inwardly thicker rear and front wall portions providing shoulders 22 and 23 respectively and on which the timber insert rests. The narrower lower portion 21 may assist in drainage and may provide a walkway for termites.

A lower wall portion 25 depends from the base wall 19 in the same plane as the rear wall 17 and extends over the full length of the base component and terminates in a free lower edge, the opposed faces tapering to a sharp edge 24.

It can be seen that the closure 13 is adapted to close the opening 15 in a substantially water tight manner. For this purpose, the closure 13 has an upper wall portion 26 which is adapted to extend across and beyond the opening 15, and two spaced apart inner skirt portions 27 and 28 adapted to fit tightly within the opening 15 depend from the upper wall portion 26, the outer faces of the two skirt portions 27 and 28 being adapted to contact the inner faces of the rear wall portion 17 and the front wall portion 18 respectively. Two external skirt portions 29 and 30 also depend from the upper wall 26, the inner faces of which are adapted to engage the outer faces of the rear wall portion 17 and front wall portion IS respectively as can be more clearly seen in FIG. 2. As also can be more clearly seen in FIG. 2, the inner skirt portions 27 and 28 of the closure, are engaged with the timber insert 12 and hold it securely in position in the gallery resting on the shoulders 22 and 23.

A plurality of slots 32 are provided in the rear wall portion 17 and the front wall portion 18 and are adapted to provide access to the timber insert 12 in the gallery 16 by termites.

As can be seen in FIG. 2, the opposite side faces of the timber insert 12 engage with the inner faces of the front and rear walls 17 and 18 so that the slots are effectively closed by the timber insert. Thus, access to the gallery 16 by black ants is prevented and termites can only gain access by eating through the timber insert 12.

The termite interceptor 10 has an overall height of about 75 mm and is installed with the upper wall 26 of the closure 13 substantially flush with the ground surface as illustrated in FIGS. 2, 9 and 10. As can be see, the interceptor 10 may act as a barrier to termites, but its primary function is direct termites to a collection container 50, as described in more detail below. Subterranean termites travelling within the upper most 75 mm of ground will strike a wall portion of the interceptor 10 and will be attracted by the timber insert 12. Alternatively, if the termite strikes the lower wall portion 25 and due to their natural instinct they will travel upwards in hope of find finding food. As such, the termite will be directed to the timber insert 12. The termite will eat through the timber insert 12 and continue to feed on it, and travel along galleries 16 they form in the timber insert 16 themselves.

The gallery 16 forms an ideal environment for termites as it attempts to replicate the tubes and tunnels they generally live in. As such, the termites cannot resist following the food source in the gallery 16 wherever it goes. In addition, the termites that have located the timber insert 12 emit scent pheromones that detected by other termites in the area, thereby attracting large numbers of termites to the galleries 16 of the interceptor 10. Suitably, the interceptor 10 directs the termite to a collection container 50.

As can be seen in FIGS. 7 and 8, the interceptor 10 is installed around the perimeter of a house 40 or yard with the free ends of the gallery 16 being capped, and a single or plurality of spaced apart termite collection containers 50 are placed in the line of the interceptor 10. That is to say, the interceptors 10 are arranged so that the galleries 16 extend into or communicate with the termite collection containers 50. Accordingly, the termites travelling in the galleries 16 can enter the termite collection containers 50 to obtain food which is placed therein. Suitably, the interceptors 10 are placed so that a termite is more likely to strike the interceptor 10 rather than a building 40.

As can be seen in FIGS. 3 and 16, the termite collection container 50 is rectangular in shape having two opposed spaced apart end walls 51 and 53, two opposed spaced apart side walls 52 and 54, and a base wall 55 defining a chamber 56, and an upper wall 57 forming a closure. The side wall 54 has a termite access opening 58 therein which corresponds in size and shape to the access openings 32 in the barrier 10. As such, the termite collection container 50 can be placed adjacent the interceptor 10 with one access opening 32 abutting the opening 58. The container 50 can secured to the interceptor by screws, adhesive or other suitable means with the two openings 32 and 58 in line to provide a passage for termites from the gallery 16 to the container 50. In other embodiments, the access opening 58 has a different shape adapted to receive therethrough an end portion of the gallery 16. Alternatively, connecting tubing or the like may be link the end portion of gallery 16 to the access opening 58. The container 50 is divided into an upper chamber, a middle chamber and a lower chamber by horizontal partitions 59a and 59b. In this embodiment, the upper and lower chambers are food chambers while the middle chamber is a viewing chamber. The partitions 59a and 59b have suitable access apertures to allow the termites to move throughout the entire chamber.

An activity indicator assembly is installed in the termite collection container as indicated generally at 60. The activity indicator 60 includes an indicator rod 61 adapted to indicate termite activity in the termite collection container 50 which extends upwardly from the closure wall 57 and is movable from a retracted position as shown in FIG. 9 in which it is almost flush with the closure wall to an extended position as shown in FIG. 10 in which it protrudes well above the closure wall 57. The retracted position indicates none or little termite activity in the container while the extended position indicates significant activity. The indicator rod 61 is a sleeve which is slidably mounted on a rod 62 with a spring 63 mounted between the upper blind end of the sleeve and a solid end 64 of the rod 62 and adapted to bias the sleeve to the extended indicating position. At its lower end, the sleeve has an outwardly extending flange 66 adapted to engage with the inner face of the base wall 55 when the indicator is in the retracted position. The sleeve is selectively held in the retracted position by a piece of cork 67 which is jammed under a lug 68 that is secured to the base wall 55 of the container.

At the time of installation the indicator rod 61 is moved to the retracted position and secured in that position by fitting the cork 67 to the position shown in FIG. 9. It is believed that cork 67 is a particularly attractive food for termites. Once the termites eat the cork 67, it weakens and breaks allowing the spring 63 to force the sleeve to the extended visible position through the opening 65 which is covered by a clear plastic cover 69.

As second embodiment of an activity indicator assembly is illustrated in FIGS. 13 to 15 includes a trigger chamber 90 filled with a bait 91, such as cardboard, tissue paper or other cellulose materials. A trigger tab 92 is inserted or embedded in the layers of the cardboard bait 91 and extends through the chamber 90. The trigger tab 92 may also be substantially composed of cardboard and is firmly attached to a cable 93 via a tension lock 99. The other end of the cable 93 is attached und tension by a spring 94 to an indicator 95 that enable a viewer to determine when there is termite activity in the container 50, without having to open the container. The indicator 95 comprising an indicator flag 96 enclosed within a housing 97. The cable 93 inserts into the housing 97 and is attached to the flag 96. The upper portion of housing 96 includes a clear viewing window 98.

As such, the indicator flag 96 is movable from a retracted position where it is position below the level of the viewing window 98 to an extended position where it can be seen in the window 98. Similar to the embodiment illustrated in FIGS. 9 and 10, if the flag 96 is in a retracted position it cannot be seen in the viewer window 98 indicating that there is little or no termite activity in the container 50. On the other hand, significant activity is indicated if the flag is in an extended position and can be seen in the viewer window 98.

If termites have managed to gain entry into the container 50, they will be immediately attracted to the bait 91 in the trigger chamber 90. If either the bait 91 or the trigger tab 92 is sufficiently devoured, the cable 93 will be released from the tab 92 recoiling under the spring tension to enable the indicator flag 96 to move to an extended position where is can be seen in the viewer window 98.

An advantage of this second type of activity indicator assembly is that the indicator 95 is not necessary restricted to be in the direct vicinity of the container 50 and can be positioned in an area that is convenient to remind a viewer to check the status of the indicator 95 on a sufficiently regular basis. FIG. 16 illustrates how the second type of activity indicator assembly is mounted within a termite collection container 50 of the invention. The trigger chamber 90 is place on the lower partition 59b adjacent the access opening 58, so that the bait 91 in the activity indicator assembly is the most likely to initially feed on the trigger bait 91 than the other food located within the container. As such, the householder or a monitoring service will be provided with the early warning and the infestation of the container 50 can monitored by other indicator, such as by an optical viewer 70 or third type of indicator 80, as described below.

In other embodiments of the activity indicator assembly, the movement of the indicator rod 61 or flag 96 may activate the emission of a sound that can be heard by the householder or may activate the emission of a data signal that can registered by suitable equipment held by the householder or a base monitoring agency. For example, emitted data signals that may include an electrical, infrared, radio, wireless or any other telemetric signal that can be suitably registered for action. These embodiments are described in more detail in Example 2.

When the householder notices that the indicator rod 61 has moved to the position shown in FIG. 10 and is visible through the cover 69 or if the flag 96 is visible in the viewing window 97 of the indicator 95, he can view the activity in the viewing chamber through the glass covered viewing opening 71 in the closure wall 57. An arrangement of mirrors 72 and a filter allow the householder to view the termites in the viewing chamber 71 under a non-intrusive ultra violet light by shining a torch through the lighting tube 73. The advantage of this type of viewer is that it does not disturb the termites. The light used to view the termites is suitably filtered or is UV. Preferably, a green light is used in the lighting tube 73 and this least disturbs the termites.

FIG. 15 illustrates an alternative embodiment of an optical viewer 70 that may be removable from the container 50, if required. This optical viewer 70 includes a window 74 to viewing chamber 75 that enables the observation the activity of the termites via mirror 77 located in the lower portion of the viewing chamber 75. Two lighting chambers 75 are positioned on opposed sides of the viewing chamber 75 with lights located in the lower portion of the lighting chamber 75. Switches 79 are provided on the optical viewer 70 to enable minimal disturbance to termites located within the container 50 when viewing their activity.

The container 50 may also include a third type of indicator shown generally at 80. The third type of indicator 80 includes a tube 81 which is positioned in the container 50 extending from the closure wall 57 to the base wall 55 and is adapted to hold attractive food such as cardboard. It is believed that cardboard is less attractive than cork. The tube 81 has access openings 82 therein adapted to allow termites access to the food. The householder can check on the level of activity by withdrawing the activity tube 80 from the container 50 and ascertaining whether there are any termites present in the tube. If only the lower end of the tube 81 is infested, this indicates that only the lower chamber is infested. If the upper end of the tube 82, then the viewer can reasonably surmise that the whole chamber of the container 50 is infested.

In use, the galleries 16 of the interceptor 10 and the collection container 50 are stock with food source. A bag lines the bottom to the lower chamber of the container 50 formed by partition 59b followed by the addition timber shavings to the lower chamber. The activity indicator assembly is then installed in at least the middle chamber of the container 50 in a retracted position and then the second partition 58a is placed into position. A second bag lines the partition 58a and more food is placed on the bag in the formed upper chamber. It should be noted that the bags are appropriated positioned so as not to hinder the movement of the termites throughout the container 50. The closure 57 is then placed on top of the container.

The bait 57, 91 of the activity indicator assembly is suitably positioned adjacent an access openings 58 so it is first food source located by the termites. As such, the householder will obtain an early indication that the container has been infested by noting that the indicator rod 61 or indictor flag 96 has moved to a visible extended position. As such, the householder can either monitor the activity of the termites in the container themself or they could contact a professional. The increased activity of termites in the container 50 can be monitored through the used of an optical viewer 70 and/or the tube indicator 80. It is preferable to delay treating the termites with toxicant until there is a peak infestation before the food source is depleted.

When it is determined that there are sufficient termites in the container 50 to effect a satisfactory dusting operation, an authorised person should contacted to lift the lid and treat the termites in the container with a carrier poison, such as with arsenic trioxide. In order to harvest the termites, the second bag located in the upper chamber is generally lifted out and the termites are separated from food. It preferable that the termites are dusted with arsenic trioxide as this has proven in the past to be an effective means of exterminating the nest. However, in some countries arsenic trioxide is not approved for use. In that case, any suitable termite toxicant may be applied to the termites.

The dusted or otherwise treated termites are placed back into the lower and middle chambers of the container 50. A partition 58a without any openings is placed in the container to prevent the termites from moving into the upper chamber. A stainless steel closure 57 or the like is preferable placed on the container to prevent any contamination of the termite toxicant. As the termites have been disturbed by the dusting process, they quickly travel out of the container 50 through the opening 58 into the galleries 16 and back to the main nest and contaminate the main nest to cause the death of the entire colony.

After a suitable amount of time has passed since release of the captured termites, the container 50 is opened again and the first bag is removed cleaning the container of the remaining scraps and any residue toxicant. The container 50 and the gallery 16 can then be reset with food source and bait

One of the advantages of the apparatus and methods for termite detecting and monitoring termite activity is that the system allows for the collection of a sufficient amount of termites to provide

### EXAMPLE 2

The present invention also encompasses a remote monitoring system for monitoring of termite activity within a designated area. In preferred embodiments, the remote monitoring system utilises the apparatus and methods used to detect and monitor termite activity described in Example 1. The only requirement to enable remote monitoring is that upon registering termite activity in the container 50 the activity indicator assembly emits a suitable data signal that can be acted upon by appropriate professionals upon registering the emitted signal by appropriate equipment located at a base monitoring station. The visual signal described above as viewed by the householder by the extending of the indicator rod 61 or flag 96 may or may be incorporated into the remote monitoring system. The visual signal may be included as a back up in the circumstance that their is equipment failure due to unforeseen circumstance.

The emitted data signal may be electrical, infrared, radio, wireless, satellite, GPS or any other suitable telemetric signal. It is to be understood that the technology to emit and register such data signals is well known technology. Accordingly, it would not be an undue burden for a person skilled in the art to adapt the known technology or any other technology that may become available in the future to the present invention of remote termite monitoring systems.

The emitted signal may be registered by any appropriate means. For example, the signal may be registered by a computer that generates a suitable response to enable action such as by telephone call, an email or any other suitable alert mechanism. Suitably, the data signal also includes address information so that the registrant can determine where the termite activity is located and thereby they can act immediately in order to control the termites.

Suitably the remote monitoring system of the invention is hard wired such that if the means that enables the data signal to be emitted is disabled or if the means to register the signal at the base station is disabled, then a suitable message can be transmitted either to the householder and/or to the monitoring station in order that they may rectify the disablement.

An advantage of the remote monitoring system is that the need for regulated on-site manual inspections may be reduced or avoided all together. Essentially the remote monitoring system of the invention can be regulated similarly to an intruder or fire alarm system. Upon registering an emitted data signal that indicates termite activity, a professional can then conduct an on-site inspection to determine the extent of the termite activity and to place implement suitably procedures to control and hopefully exterminate the originating termite colony/

It will of course be realised that while the foregoing has been given by way of illustrative example of this invention, all such and other modifications and variations thereto as would be apparent to persons skilled in the art are deemed to fall within the broad scope and ambit of this invention as is herein set forth.

1. Termite detection and monitoring apparatus including:
a container configured to hold a quantity of termite attractive food, the container having at least one access opening to enable termite access to the food;
a termite interceptor adapted to direct termites into the container, one end of the interceptor communicating with an access opening of the container and the other end of the interceptor extending in a direction away from the container, and
a termite activity indicator associated with the container adapted to indicate a predetermined level of termite activity in the container.

2. A termite detection and monitoring apparatus according to claim 1, wherein the interceptor includes a food source.

3. A termite detection and monitoring apparatus according to claim 1 or claim 2, wherein the interceptor is installed at least part way in or around a building so that the likelihood that termite infestation is more likely to occur in the interceptor or the container than the building.

4. A termite detection and monitoring apparatus according to any one of claim 1 to 3, wherein the termite activity indicator emits a visual, electrical, infrared, radio, wireless satellite, GPS signal or any other telemetric signal upon detecting termite activity in the container.

5. A termite detection and monitoring apparatus according to any one of claims 1 to 4, wherein the apparatus is installed in a building or in the ground around a building.

6. A method of detecting and/or monitoring termite infestation of a building including:
providing a termite interceptor as previously described within the vicinity of a building to be protected;
providing a termite collection container and providing communication between the termite interceptor and the container to termite access openings to enable of travel termites from the interceptor into collection container, and
providing a termite activity indicator associated with the container to detect a predetermined level of termite activity in the container,
wherein upon detection a predetermined level of termite activity within the contain treatment steps are undertaken to treat the termites collected in the collection container with a carrier poison.

7. A termite collection container including:
one or more walls defining a chamber having a food input opening, said chamber being adapted to contain food attractive to termites and a removable closure adapted to close said food input opening;
a termite access opening in at least one of said one or more walls to provide access for termites to said chamber;
a termite activity indicator operatively connected to said chamber and adapted to indicate a predetermined level of termite activity in said chamber, and
actuating means for actuating said termite activity indicator.
